(19) United States
(12) Patent Application Publication
(10) Pub. No.: US 2008/0052588 A1
(43) Pub. Date: Feb. 28, 2008

(54) SYSTEM AND METHOD TO SEND ACK/NACK WITHIN ASSIGNMENT MESSAGE FOR REVERSE LINK TRAFFIC IN A COMMUNICATION SYSTEM

(75) Inventors: Shukla AKASH, Bangalore (IN); Tirumala Sree Hari Vara Prasad Vadlapudi, Bangalore (IN); Satya Venkata Uma Kishore Godavarti, Bangalore (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO. LTD.,, Suwon-si (KR)

(21) Appl. No.: 11/844,221

(22) Filed: Aug. 23, 2007

(30) Foreign Application Priority Data
Aug. 24, 2006 (IN) 1521/CHE/2006

(51) Int. Cl. H04L 1/18; G06F 11/16

(52) U.S. Cl. 714/748; 714/E11.058

(57) ABSTRACT

A method and system to send an acknowledgement/negative acknowledgement (ACK/NACK) for High Rate Packet Data (HRPD) transmission. An ACK/NACK is encoded within an assignment message on a Forward Shared Signaling Channel (F-SSCH), which in turn saves bandwidth separately reserved for ACK/NACK transmission and also transmit power to send the ACK/NACK bits.

### PRIORITY

This application claims priority under 35 U.S.C. § 119 to an application filed in the India Intellectual Property Office on Aug. 24, 2006 and assigned Ser. No. 1521/CHE/2006, the contents of which are incorporated herein by reference.

### BACKGROUND OF THE INVENTION

1. Field of the Invention

The present invention generally relates to the field of communication, and more particularly to a system and method to send an acknowledgement (ACK) and/or negative acknowledgement (NACK) within an assignment message for reverse traffic link in a communication system.

2. Description of the Related Art

Wireless communication using Access Terminals (ATs) and Access Networks (ANs) has experienced significant improvements over the years. Recently, a harmonized proposal for the High Rate Packet Data (HRPD) rev C and the Institute of Electrical and Electronics Engineers (IEEE) 802.20 standard has been discussed. In the HRPD Rev C specification, Forward Shared Signaling Channel (F-SSCH) carries Link Assignment Messages (LAMs) for forward and reverse traffic. F-SSCH also carries acknowledgement of the reverse traffic. For a non-persistent assignment, the assignment is given to an AT when the assignment duration expires. The duration of the assignment is defined such that the assignment expires when the packet is successfully decoded or the maximum number of retransmission has expired.

U.S. Patent Application Publication No. U.S. 20050165949 A1 (publication '949), published on Jul. 28, 2005, describes a method where an acknowledgement message after being combined with a communication message is transmitted on a single channel. The communication message may either be a Forward Link Assignment Message (FLAM) or a Reverse Link Assignment Message (RLAM), and the channel on which the message gets transmitted may be a F-SSCH. However, publication '949 does not suggest using an available block type or utilizing reserved bits of an assignment message to convey ACK information.

U.S. Patent Application Publication No. U.S. 20040109433 A1 (publication '433), published on Jun. 10, 2004, describes a method, where a forward control channel is used to send acknowledgement information about data packets sent by a mobile station to the base station on the reverse link, instead of using a separate acknowledgement channel. According to the publication, along with the scheduling information sent on the control channel, the channel also carries ACK/NACK bits for reverse traffic, which thereby frees the bandwidth reserved separately for the acknowledgement channel. Publication '433, however, does not suggest using an available block type or utilizing reserved bits of scheduling information to convey ACK information.

In the harmonized proposal for the HRPD rev C and the IEEE 802.20 standard, there are persistent and non-persistent types of assignment in the F-SSCH. For non-persistent assignments, there is a need to give the Reverse Link (RL) assignment to the AT when duration of the assignment is finished. At the same time, the AN needs to transmit the NACK also for the RL traffic. For this purpose the F-SSCH is used with an encoded block segment for an assignment purpose and NACK segment for an ACK/NACK purpose. Three modulation symbols are used to transmit an ACK. NACK is not transmitted as the ON/OFF keying mechanism used for this purpose.

A need exists to encode a NACK within an assignment block as assignment and ACK are both going to the same AT. This will save the ACK node reserved for this purpose as well transmit power needed to transmit the ACK bits. These saved sub carriers can be used for some other purpose (control or user data depending on the scheduling). Only one bit will be used for this purpose in the assignment block, while 9 bits were needed to transmit if an ACK/NACK segment is used.

### SUMMARY OF THE INVENTION

Accordingly, the present invention substantially solves at least the above-mentioned problems and provides a system and method to send an ACK/NACK within an assignment message for reverse link traffic in a communication system.

In the present invention, when a NACK is coded in an assignment block with a less number of bits, and hence the modulation symbols/sub carriers, as well as less power are needed to transmit the NACK.

According to an aspect of the present invention, a method is provided to send an ACK/NACK within an assignment message for reverse link traffic in a communication system, the method including encoding an ACK/NACK within the assignment message on an F-SSCH, thereby saving bandwidth separately reserved for ACK/NACK transmission and saving transmit power to send ACK/NACK bits.

According to another aspect of the present invention, a system is provided to send an ACK/NACK within an assignment message for reverse link traffic in a communication system, the system including means for encoding ACK/NACK within the assignment message on an F-SSCH, thereby saving bandwidth separately reserved for ACK/NACK transmission and saving transmit power to send ACK/NACK bits.

Other aspects, features, and advantages of the present invention will become more apparent from the ensuing detailed description of the invention, taken in conjunction with the accompanying drawings.

### BRIEF DESCRIPTION OF THE DRAWINGS

The above and other aspects, features and advantages of the present invention will become more apparent from the following detailed description when taken in conjunction with the accompanying drawings in which:

FIG. 1 are F-SSCH assignment blocks for RLAM and FLAM according to the prior art;

FIG. 2 is an RL H-ARQ transmission timing with an FDD eight interlace;

FIG. 3 is an Assignment Message having an ACK-bit within the message according to the present invention;

FIG. 4 are Assignment Messages having Block types according to the present invention;

FIG. 5 is RL H-ARQ transmission with Assignment Messages according to the present invention; and

FIG. 6 is an HRPD wireless communication network according to the present invention.

### DETAILED DESCRIPTION OF THE PREFERRED EMBODIMENTS

Preferred embodiments of the present invention are described below with reference to the accompanying drawings. However, the disclosed embodiments are merely examples of the present invention that may be configured in various ways. Therefore, details of the present invention disclosed herein are not to be interpreted as limiting but merely for teaching one skilled in the art how to make or use the invention.

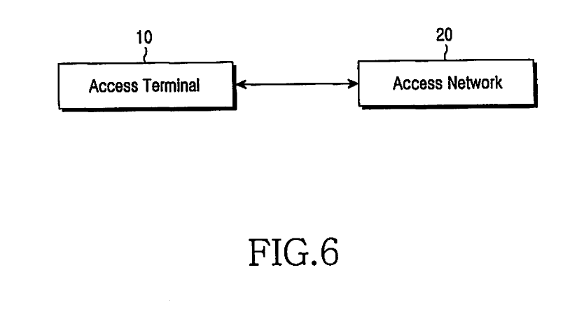

FIG. 6 shows a High Rate Packet Data (HRPD) wireless communication network according to the present invention. The HRPD network in FIG. 6 includes an Access Terminal (AT) 10 and an Access Network (AN) 20. A Forward Shared Signaling Channel (F-SSCH) is present in each Forward Link Physical (FL PHY) Frame and includes four segments populated over hop-ports according to a Shared Signaling Media Access Control (SS MAC) Protocol. These four segments include an Encoded Block Segment, an Acknowledgement Segment, a Power Control Segment, and a Fast Open Systems Interconnection (OSI) Segment.

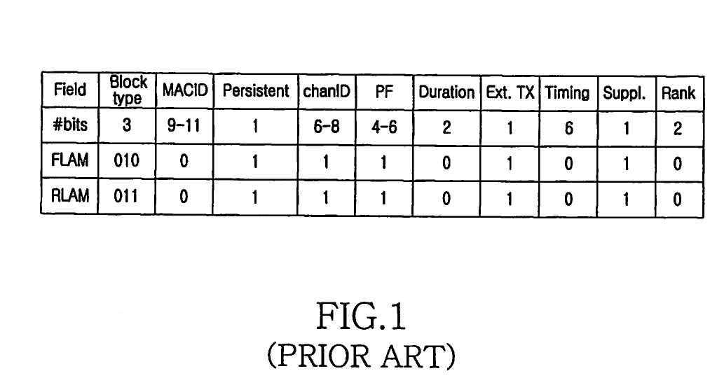

The Encoded Block Segment of the F-SSCH carries assignments for Forward Link (FL) and Reverse Link (RL) traffic Resources. A selection of FL signaling messages, referred to herein as a Link Assignment Message (LAM), is shown as a table in FIG. 1. Columns of the table in FIG. 1 indicate different fields while rows correspond to different signaling blocks. Every cell in the table indicates multiplicity of a given field. A 3-bit block type field allows the AT to identify the type of block and therefore interpret the subsequent fields. The set of information bits of every block is extended by a 16-bit CRC to enable reliable detection.

The Acknowledgement Segment of F-SSCH carries acknowledgement bits for RL traffic. This segment is used to acknowledge RL Hybrid Automatic Repeat reQuest (H-ARQ) transmissions and therefore is present in every FL PHY frame to acknowledge the associated RL PHY frame. Each acknowledgement (ACK) is a one bit message which uses three modulation symbols to carry the ACK message. NACK bits are encoded using on/off keying so the absence of an ACK transmission implies a negative acknowledgement.

The reverse link power control segment carries Channel Quality Indicator (CQI) erasure indicator bits that are used to indicate RL channel quality. The reverse link power control segment can also carry optional power control bits for ATs that are being served on the reverse link by this sector.

The Fast OSI Segment is an optional segment, which is used to provide other sector interference indication to an AT from sectors in its active set.

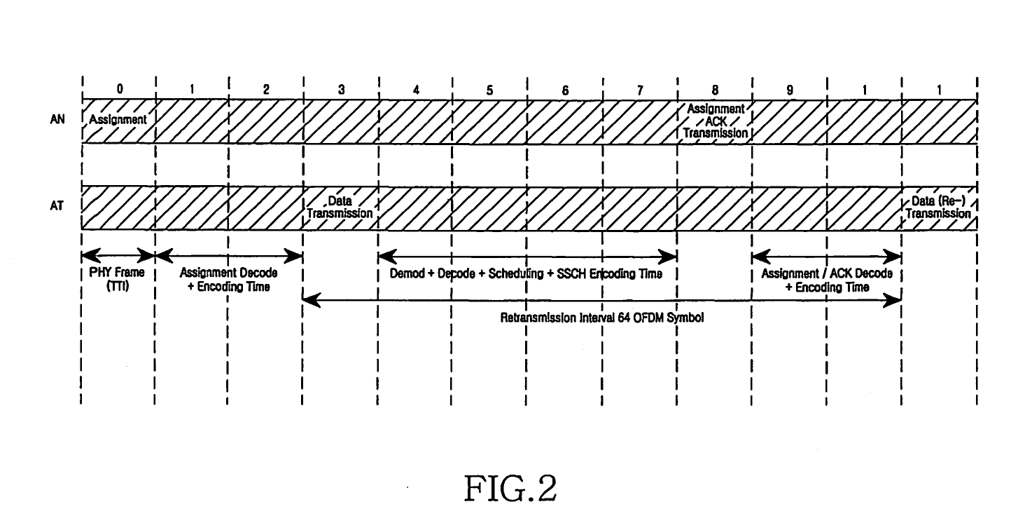

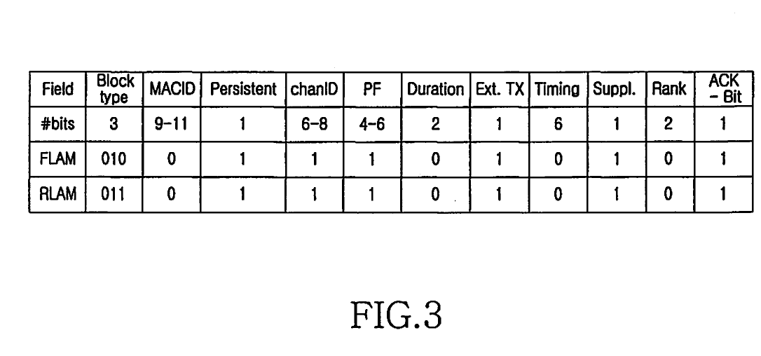

The RL traffic mechanism is shown in FIG. 3 with a Frequency Division Duplex (FDD) eight interlace timeline. For the RL traffic, as shown in the FIG. 2, a non persistent assignment message is given at the 0^{th} interlace, and then the AT transmits the data packet at the 2nd interlace. At the 8^{th} interlace the RL traffic gives an Assignment message as well as an acknowledgement for the data packet received. Then at the 11^{th} interlace either a new data packet or the retransmitted data packet of the previous data packet is sent based on the ACK/NACK. In this method of resource assignment and ACK encoding, there is a possibility to encode the ACK/NACK within the assignment message. This will save the ACK node reserved for this purpose as well as power needed to transmit ACK bit. These saved sub carriers can be used for some other purpose (control or user data depending on the scheduling). Only one bit will be used for this purpose in the assignment block, while 9 bits were needed to transmit when an ACK/NACK segment is used.

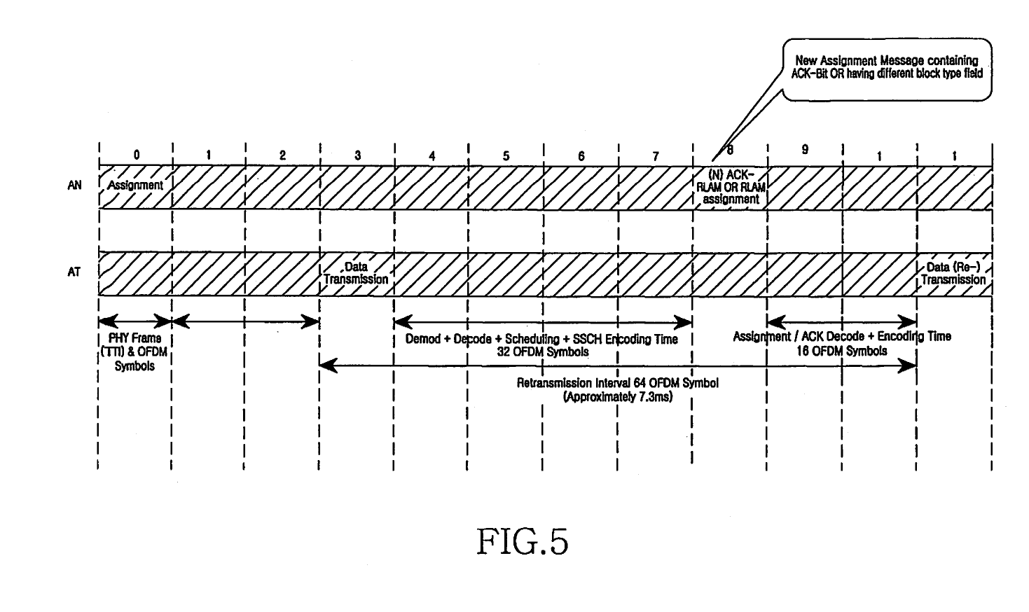

An assignment message according to the present invention is shown as a table in FIG. 3. In the present invention a one bit field is introduced in both the RLAM and FLAM link assignment messages. FLAM can be used when there is forward link traffic for the same AT. The FLAM field is shown as an ACK-Bit. When the ACK-bit is set to ‘1’, the ‘1’ shows the acknowledgement and when ACK-Bit is set to ‘0’, the ‘0” shows Negative Acknowledgement. Alternatively, the ACK-bit can be set to ‘0’ to show the acknowledgement and the ACK-Bit can be set to ‘0’ to show Negative Acknowledgement. In FIG. 5 the RL traffic of an AT with an assignment message according to the present invention is shown. At the 0^{th} interlace the assignment message is given for the data. At the 8^{th} interlace, when the assignment is to be given to the AT in an RL transfer, then the assignment message RLAM, shown in FIG. 3, is given, which contains the assignment as well as the Acknowledgement (using the ACK-Bit field). If the assignment is not given to the AT in the RL transfer at the 8^{th} interlace then the ACK/NACK for the AT should be given in the ACK/NACK segment in accordance with a harmonized proposal for the HRPD rev C and the IEEE 802.20 standard.

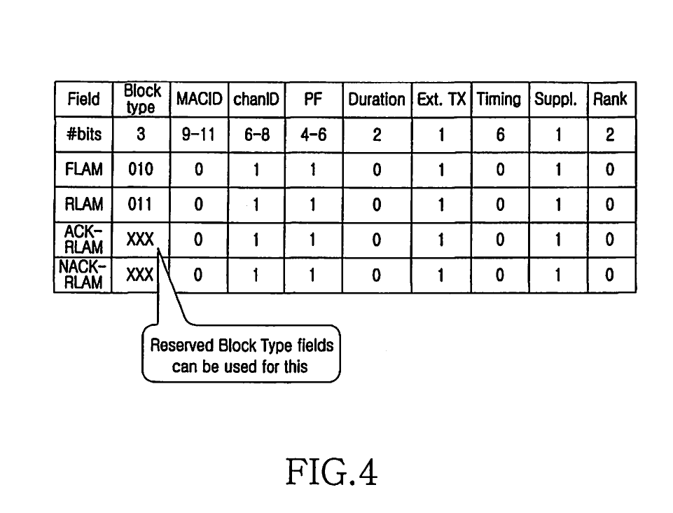

Another assignment message according to the present invention is shown as a table in FIG. 4. In FIG. 4, reserved Block Types can be used to specify the assignment messages. A new bit is not needed within the assignment message of FIG. 4. When an AT decodes the Block Type field of the assignment message, the AT becomes aware of the ACK/NACK based on the block type field. In FIG. 5 the RL traffic of an AT with new assignment message is shown. At the 0^{th} interlace the assignment message is given for the data. At the 8^{th} interlace, when the assignment is to be given to the AT in an RL transfer, then the assignment message ACK/NACK-RLAM, as shown in FIG. 4, is given, which contains the assignment as well as the Acknowledgement (using the reserved block type field). If the assignment is not given to the AT in the RL transfer at the 8^{th} interlace then the ACK/NACK for the AT is given in the ACK/NACK segment in accordance with the harmonized proposal for the HRPD rev C and the IEEE 802.20 standard.

The present invention provides a system and method to send an ACK/NACK within an assignment message for reverse link traffic in a communication system. Features of the present invention include giving an ACK within an assignment block in F-SSCH, saving sub carriers reserved for the ACK/NACK transmission by encoding the ACK/NACK within the assignment block, saving transmit power needed to send ACK bits in an ACK segment of the F-SSCH by placing the ACK/NACK within encoded block segment or any other relevant place, saving the encoding of a segment or a part of a segment by encoding it into another segment within F-SSCH to reduce the redundant bits, and saving processing and decoding time.

The present invention provides advantages that include saving Nodes used for sending the ACK/NACK. For example to send one ACK three modulation symbols, e.g. 9 bits mapped to 3 8-PSK symbols, are needed. With the present invention, modulation symbols needed to transmit the ACK are much less than the three sub carriers needed to transmit the three modulation symbols. Saved sub carriers can also be used for the purpose of the sending any other signaling data or the user data. The AN can define a way to use these saved sub carriers. In the present invention, less power is needed to transmit the ACK within the assignment segment, than the ACK segment. Over all system power saved with the present invention is considerable enough to transmit the F-SSCH in the forward direction. An AT does not need to decode the ACK segment when the ACK is given within the assignment. This ACK decode processing, and time to decode the ACK can be saved in AT.

Although preferred embodiments of the present invention have been fully described with reference to the accompanying drawings, various changes and modifications are possible and are apparent to those skilled in the art. Such changes and modifications are included within the scope of the present invention as defined by the appended claims.

What is claimed is:

1. A method to send an acknowledgement/negative acknowledgement (ACK/NACK) within an assignment message for reverse link traffic in a communication system, the method comprising:
encoding an ACK/NACK within the assignment message on a Forward Shared Signaling Channel (F-SSCH), thereby saving bandwidth separately reserved for ACK/NACK transmission and saving transmit power to send ACK/NACK bits.

2. A method as claimed in claim 1, further comprising giving the ACK within an assignment block in the F-SSCH.

3. A method as claimed in claim 1, further comprising saving sub carriers reserved for the ACK/NACK transmission by encoding the ACK/NACK within an assignment block.

4. A method as claimed in claim 1, further comprising saving the transmit power to send the ACK bits in the ACK segment of the F-SSCH by placing the ACK/NACK within an encoded block segment.

5. A method as claimed in claim 1, further comprising saving the encoding at least a part of a segment, by encoding the at least a part of a segment into another segment within the F-SSCH to reduce redundant bits.

6. A method as claimed in claim 1, wherein the Forward Shared Signaling Channel (F-SSCH) is present in Forward Link Physical (FL PHY) Frame and includes segments populated over hop-ports according to a Shared Signaling Media Access Control (SS MAC) Protocol.

7. A method as claimed in claim 6, wherein the segments include an Encoded Block Segment, an Acknowledgement Segment, a Power Control Segment, and a Fast Open Systems Interconnection (OSI) Segment.

8. A method as claimed in claim 7, wherein an Encoded Block Segment of the F-SSCH carries assignments for Forward Link (FL) and Reverse Link (RL) traffic Resources.

9. A method as claimed in claim 7, wherein an Acknowledgement Segment of F-SSCH carries acknowledgement bits for Reverse Link (RL) traffic and is present in every FL PHY frame to acknowledge an associated Reverse Link Physical (RL PHY) frame.

10. A method as claimed in claim 9, wherein an ACK is a one bit message and NACK bits are encoded using on/off keying.

11. A method as claimed in claim 7, wherein power control segment carries Channel Quality Indicator (CQI) erasure indicator bits that are used to indicate Reverse Link (RL) channel quality and additionally, carries optional power control bits for Access Terminals (ATs) that are being served on the reverse link.

12. A method as claimed in claim 7, wherein a Fast OSI Segment is an optional segment and provides other sector interference indication to an Access Terminal (AT) from sectors in an active set of the Fast OSI Segment.

13. A system to send an acknowledgement/negative acknowledgement (ACK/NACK) within an assignment message for reverse link traffic in a communication system, the system comprising:
means for encoding ACK/NACK within the assignment message on a Forward Shared Signaling Channel (F-SSCH), thereby saving bandwidth separately reserved for ACK/NACK transmission and saving transmit power to send ACK/NACK bits.
